(19) United States
(12) Patent Application Publication
(10) Pub. No.: US 2011/0047753 A1
(43) Pub. Date: Mar. 3, 2011

(54) Hinge

(75) Inventors: Hsin-Liang Yeh, Shulin (TW); Zion Lin, Shulin (TW)

(73) Assignee: Shin Zu Shing Co., Ltd.

(21) Appl. No.: 12/583,689

(22) Filed: Aug. 25, 2009

(51) Int. Cl. E05D 11/08

(52) U.S. Cl. 16/342

(57) ABSTRACT

A hinge is mounted between a cover and a base of an electronic device and has two tilting assemblies and a pivoting shaft connected to the cover, a connecting panel attached to the base, a limiting washer and an actuating washer. The actuating washer is rotated with the pivoting shaft and has at least one arc notch. The limiting washer is mounted around the actuating washer and has at least one boss inside and a limit outside. The connecting panel has a stop selectively abutting the limit. Each boss slides in the corresponding arc notch to compensate for lost rotation due embodying the stop and the limit. Therefore, the cover is rotatable by 180 degrees either clockwise or anticlockwise.

### BACKGROUND OF THE INVENTION

1. Field of the Invention

The present invention relates to a hinge, especially to a hinge that is mounted between a cover and a base of an electronic device to allow the cover to pivot and rotate relative to the base.

2. Description of the Prior Arts

Conventional electronic devices such as notebook computers, cell phones and the like comprise a cover, a base and a conventional hinge. The conventional hinge is mounted between the cover and the base to allow the cover to be tilted and rotated relative to the base. The rotatable cover is convenient for demonstrating images to other people and for user comfort. To protect internal electrical wires, the conventional hinge has a limiting structure to prevent the cover from over rotating. The limiting structure comprises a stationary limit and a rotating limit respectively connected to the base and the cover. However, both the rotating limit and the stationary limit have certain, tangible sizes, and are firmly provided on the cover and base respectively. Therefore, those elements, though they prevent the wires from damage, also prevent the cover from being rotated clockwise and anticlockwise by 180 degrees relative to the base.

To overcome the shortcomings, the present invention provides a hinge to mitigate or obviate the aforementioned problems.

### SUMMARY OF THE INVENTION

The main objective of the present invention is to provide a hinge rotatable by 180 degrees either clockwise or anticlockwise. The hinge is mounted between a cover and a base of an electronic device and has two tilting assemblies and a pivoting shaft connected to the cover, a connecting panel attached to the base, a limiting washer and an actuating washer. The actuating washer is rotated with the pivoting shaft and has at least one arc notch. The limiting washer is mounted around the actuating washer and has at least one boss inside and a limit outside. The connecting panel has a stop selectively abutting the limit. Each boss slides in the corresponding arc notch add rotation corresponding to reduction of rotation caused by embodying the stop and the limit. Therefore, the cover is rotatable by 180 degrees either clockwise or anticlockwise.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is another exploded perspective view of the hinge in FIG. 1;

FIG. 4 is a top view of the hinge in FIG. 1;

FIG. 5 is an operational top view of the hinge in FIG. 1; and

FIG. 6 is another operational top view of the hinge in FIG. 1.

### DETAILED DESCRIPTION OF THE PREFERRED EMBODIMENTS

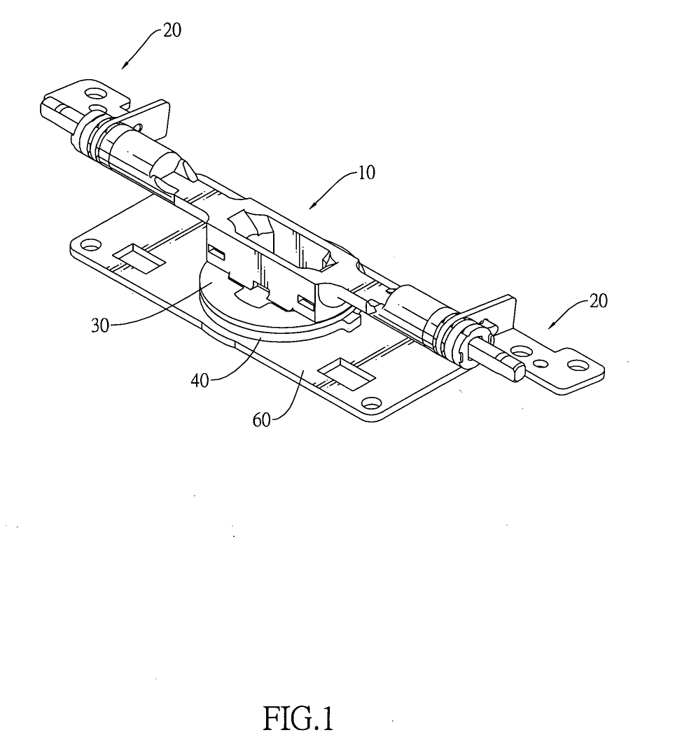

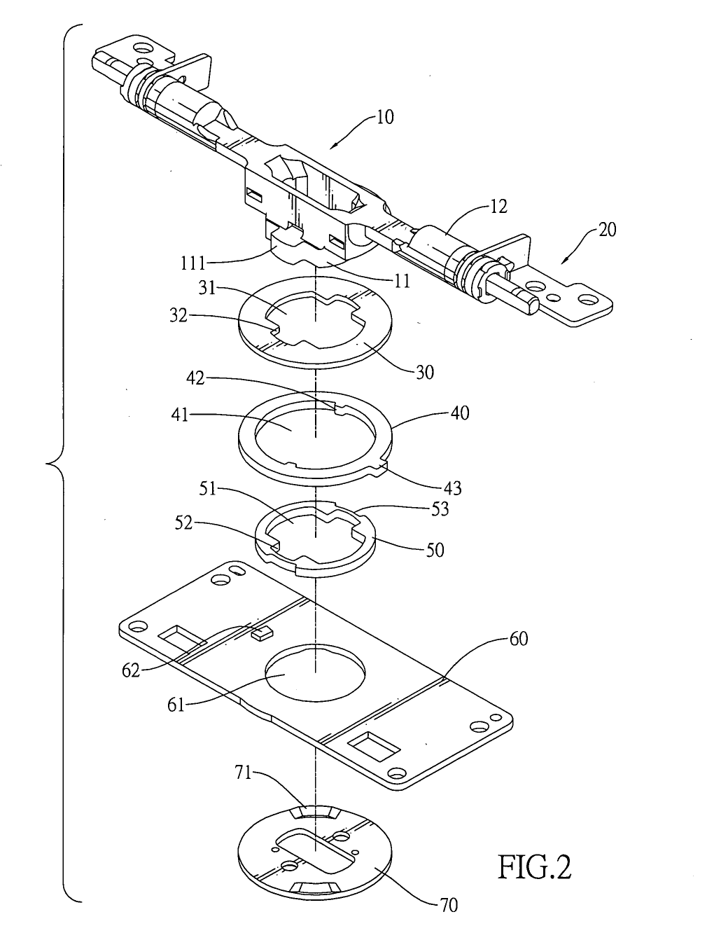

With reference to FIGS. 1 and 2, a hinge in accordance with the present invention comprises a main bracket (10), two tilting assemblies (20), an abrasion washer (30), a limiting washer (40), an actuating washer (50), a connecting panel (60) and a positioning washer (70).

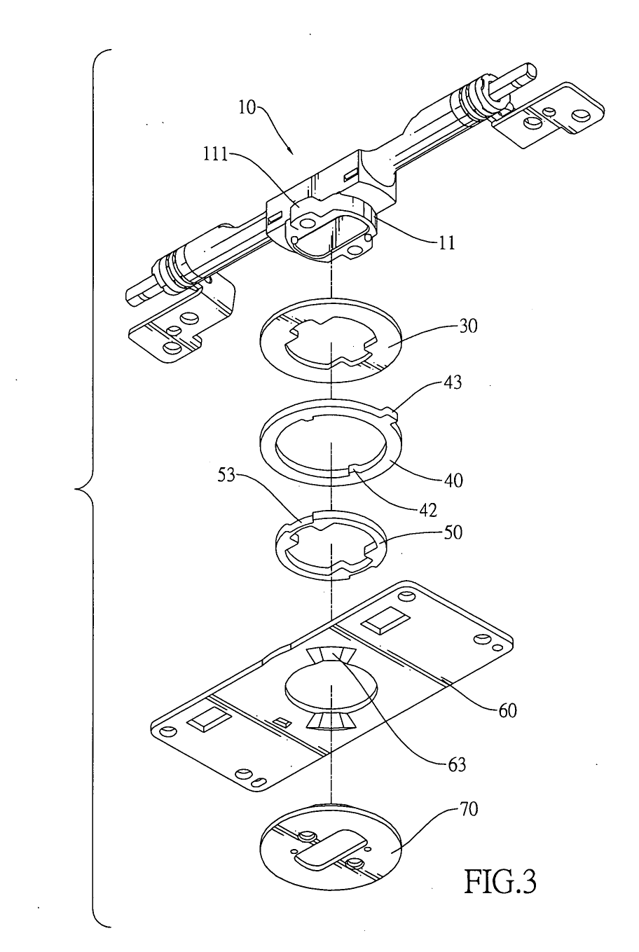

With reference to FIGS. 2 and 3, the main bracket (10) has a pivoting shaft (11), two fastening protrusions (111) and two tilting shafts (12). The fastening protrusions (111) are formed on and protrude transversely out from an annular edge of the pivoting shaft (11). The tilting shafts (12) are formed on and protrude transversely out from the annular edge of the pivoting shaft (11) and are opposite to each other.

The tilting assemblies (20) are connected respectively to the tilting shafts (12) to allow a cover of an electronic device to be tilted relative to a base of the electronic device. Detailed structures and alteration are well known in the art and are not discussed here.

The abrasion washer (30) is mounted securely around the pivoting shaft (11) via a central hole (31). Two fastening recesses (32) are formed in an inner wall of the abrasion washer (30), communicate with the central hole (31) of the abrasion washer (30) and respectively engage the fastening protrusions (111) of the pivoting shaft (11).

The limiting washer (40) is mounted rotatably around the pivoting shaft (11) via a central hole (41), is mounted adjacent to the abrasion washer (30) and has at least one boss (42) and a limit (43). The at least one boss (42) is formed on and protrudes transversely out from an inner wall of the limiting washer (40). In a preferred embodiment, the limiting washer (40) has two bosses (42) are opposite to each other. The limit (43) is formed on and protrudes transversely out from an outer wall of the limiting washer (40).

The actuating washer (50) is mounted securely around the pivoting shaft (11) via a central hole (51), is mounted rotatably in the central hole (41) of the limiting washer (40) and has two fastening recesses (52) and at least one arc notch (53). The fastening recesses (52) are formed transversely in an inner wall of the actuating washer (50) and engage the fastening protrusions (111) of the pivoting shaft (11). The at least one arc notch (53) is formed transversely in an outer wall of the actuating washer (50). In a preferred embodiment, the actuating washer (50) has two arc notches (53) being opposite to each other. The boss (42) is mounted slidably in a corresponding arc notch (53).

The connecting panel (60) is mounted rotatably around the pivoting shaft (11) via a central hole (61), is mounted adjacent to the limiting washer (40) and the actuating washer (50) and has a stop (62) and two positioning detents (63). The stop (62) is formed on a top surface of the connecting panel (60) and selectively abuts the limit (43) of the limiting washer (40). The positioning detents (63) are formed in a bottom surface of the connecting panel (60). Each positioning detent (63) has two inclined ends.

The positioning washer (70) is attached securely to the pivoting shaft (11) via fasteners, is mounted adjacent to the bottom surface of the connecting panel (60) and has two positioning protrusions (71). The positioning protrusions (71) are formed on a top surface of the positioning washer (70) and selectively engage the positioning detents (63) of the connecting panel (60) to provide positioning function.

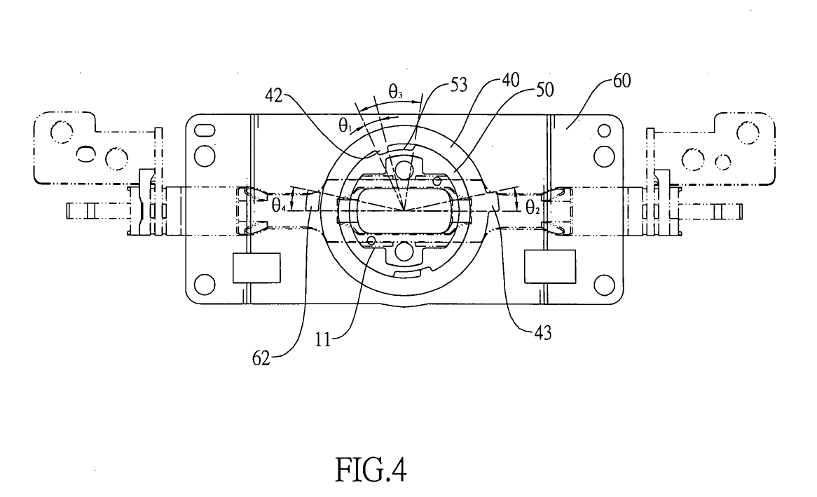

With reference to FIG. 4, the central holes (41, 51, 61) of the limiting washer (40), the actuating washer (50) and the connecting panel (60) are concentric. Each boss (42) corresponds to a first central angle θ₁. The limit (43) corresponds to a second central angle θ₂. Each arc notch (53) corresponds to a third central angle θ₃. The stop (62) corresponds to a fourth central angle θ₄. The central angles are related by the following formula:

θ₃−θ₁=θ₂+θ₄

The hinge as described is mounted in the electronic device between the cover and the base. The tilting assemblies (20) are connected to the cover. The connecting panel (60) is attached to the base. The cover is tilted relative to the base via the tilting assemblies (20). The cover is rotated relative to the base via the pivoting shaft (11). At the initial position, each boss (42) abuts a first end of the corresponding arc notch (53).

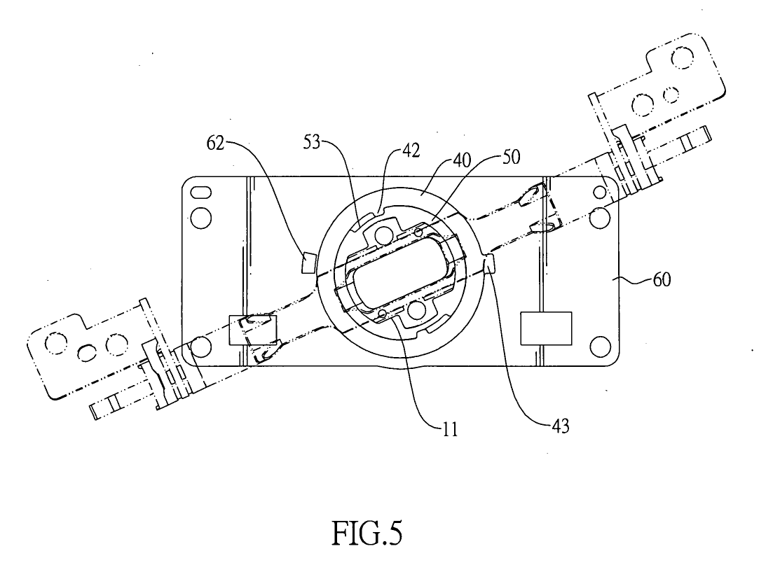

With reference to FIG. 5, when the cover is rotated anticlockwise relative to the base, the pivoting shaft (11) rotates the actuating washer (50). Therefore, the arc notch (53) of the actuating washer (50) slides relative to the boss (42) of the limiting washer (40) until the boss (42) abuts the second end of the arc notch (53). Once the boss (42) abuts the second ends of the arc notch (53), the limiting washer (40) is rotated with the actuating washer (50) when the cover is kept rotated anticlockwise.

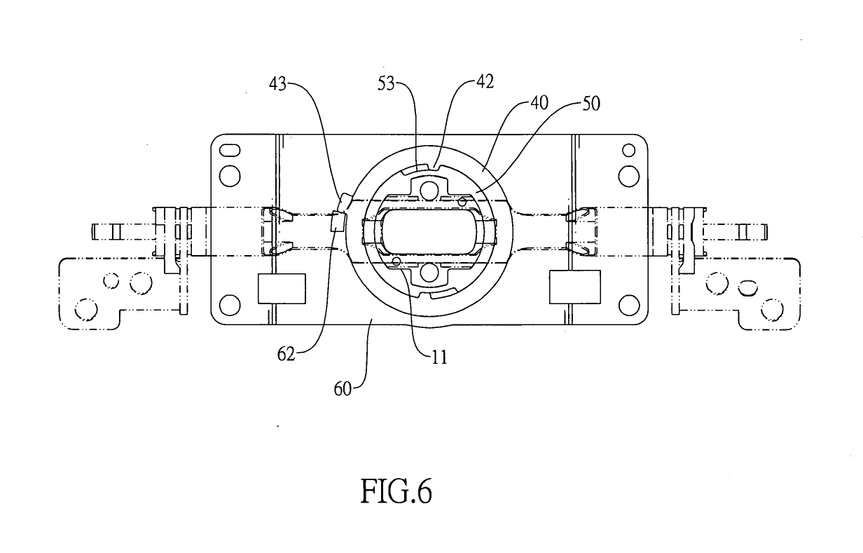

With reference to FIG. 6, when the limit (43) of the limiting washer (40) abuts the stop (62) of the connecting panel (60), the limiting washer (40) is stopped from rotating so that the rotating angle of the cover is limited. Because θ₃ minus θ₁ is equal to θ₂ plus θ₄, the cooperation between the boss (42) and arc notch (53) compensates for reduced rotation caused by embodying the limit (43) and the stop (62). Therefore, the pivoting shaft (11) is rotatable by 180 degrees either clockwise or anticlockwise, and the cover has a full range of viewing angles.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a main bracket having
a pivoting shaft; and
two tilting shafts formed on and protruding transversely out from the annular edge of the pivoting shaft and opposite to each other;
two tilting assemblies connected respectively to the tilting shafts;
a limiting washer mounted rotatably around the pivoting shaft via a central hole of the limiting washer and having
at least one boss formed on and protruding transversely out from an inner wall of the limiting washer; and
a limit formed on and protruding transversely out from an outer wall of the limiting washer;
an actuating washer mounted securely around the pivoting shaft via a central hole of the actuating washer, mounted rotatably in the central hole of the limiting washer and having
at least one arc notch formed transversely in an outer wall of the actuating washer, and each of the at least one boss of the limiting washer mounted slidably in a corresponding arc notch; and
a connecting panel mounted rotatably around the pivoting shaft via a central hole of the connecting panel, mounted adjacent to the limiting washer and the actuating washer and having
a stop formed on a top surface of the connecting panel and selectively abutting the limit of the limiting washer, wherein
the at least one boss corresponds to a first central angle, the limit corresponds to a second central angle, the at least one arc notch corresponds to a third central angle, the stop corresponds to a fourth central angle, when the first central angle is subtracted from the third central angle such result equals the sum of the second central angle and the fourth central angle.

2. The hinge as claimed in claim 1, wherein
the main bracket has two fastening protrusions formed on and protruding transversely out from an annular edge of the pivoting shaft; and
the actuating washer has two fastening recesses formed transversely in an inner wall of the actuating washer and engaging the fastening protrusions of the pivoting shaft.

3. The hinge as claimed in claim 2 further comprising an abrasion washer mounted securely around the pivoting shaft via a central hole of the abrasion washer and having two fastening recesses formed in an inner wall of the abrasion washer, communicating with the central hole of the abrasion washer and respectively engaging the fastening protrusions of the pivoting shaft.

4. The hinge as claimed in claim 1 further comprising a positioning washer, wherein
the connecting panel has two positioning detents formed in a bottom surface of the connecting panel, and each positioning detent has two inclined ends; and
the positioning washer is attached securely to the pivoting shaft, is mounted adjacent to the bottom surface of the connecting panel and has two positioning protrusions formed on a top surface of the positioning washer and selectively engaging the positioning detents of the connecting panel.

5. The hinge as claimed in claim 2 further comprising a positioning washer, wherein
the connecting panel has two positioning detents formed in a bottom surface of the connecting panel, and each positioning detent has two inclined ends; and
the positioning washer is attached securely to the pivoting shaft, is mounted adjacent to the bottom surface of the connecting panel and has two positioning protrusions formed on a top surface of the positioning washer and selectively engaging the positioning detents of the connecting panel.

6. The hinge as claimed in claim 3 further comprising a positioning washer, wherein
the connecting panel has two positioning detents formed in a bottom surface of the connecting panel, and each positioning detent has two inclined ends;and
the positioning washer is attached securely to the pivoting shaft, is mounted adjacent to the bottom surface of the connecting panel and has two positioning protrusions formed on a top surface of the positioning washer and selectively engaging the positioning detents of the connecting panel.
